(19) United States
(12) Patent Application Publication
(10) Pub. No.: US 2016/0379306 A1
(43) Pub. Date: Dec. 29, 2016

(54) OPTIMIZED RESOURCE ALLOCATION

(71) Applicant: Christopher Sean Slotterback, Staatsburg, NY (US)

(72) Inventor: Christopher Sean Slotterback, Staatsburg, NY (US)

(21) Appl. No.: 15/192,270

(22) Filed: Jun. 24, 2016

Related U.S. Application Data
(60) Provisional application No. 62/184,153, filed on Jun. 24, 2015.

(51) Int. Cl. G06Q 40/06; H04L 12/24; H04L 12/26

(52) U.S. Cl. CPC G06Q 40/06; H04L 43/16; H04L 41/22

(57) ABSTRACT

Systems and methods are provided for optimal resource allocation to a plurality of factors. A parameter estimation component is configured to determine an estimated per unit value for each of a plurality of factors, an estimated covariance matrix for the plurality of factors, and a synthetic time series randomly generated from historical values selected for each of the plurality of factors. A risk evaluation component is configured to determine a constraint for the resource allocation from the synthetic time series, such that a conditional value at risk for a set of resources represented by the resource allocation constrained to a threshold value over a defined period of time. An optimization component is configured to determine an allocation of the set of resources to the plurality of factors having a maximum utility given the constraint, the estimated per unit value, and the estimated covariance matrix.

### RELATED APPLICATIONS

This application claims priority to U.S. Provisional Patent Application Ser. No. 62/184,153, filed Jun. 24, 2015, the entirety of which is herein incorporated by reference.

### FIELD OF THE INVENTION

The invention relates generally to expert systems, and more specifically, to systems and methods for optimizing resource allocation.

### BACKGROUND OF THE INVENTION

In strategic planning, resource allocation is a plan for using available resources, for example human resources, especially in the near term, to achieve goals for the future. It is the process of allocating scarce resources among the various projects or business units. There are a number of approaches to solving resource allocation problems. In general, resources can be allocated using a manual approach, an algorithmic approach, or a combination of both. In the algorithmic approach, resource allocation can be decided by using computer programs applied to a specific domain to automatically and dynamically distribute resources to applicants. This approach is utilized in electronic devices dedicated to routing and communication. For example, channel allocation in wireless communication can be decided by a base transceiver station using an appropriate algorithm.

### SUMMARY OF THE INVENTION

In accordance with an aspect of the present invention, a system is provided for optimal resource allocation to a plurality of factors. The system includes a processor and a non-transitory computer readable medium operatively connected to the processor and storing machine executable instructions. The machine executable instructions include a parameter estimation component configured to determine an estimated per unit value for each of a plurality of factors, an estimated covariance matrix for the plurality of factors, and a synthetic time series randomly generated from historical values selected for each of the plurality of factors. A risk evaluation component is configured to determine a constraint for the resource allocation from the synthetic time series, such that a conditional value at risk for a set of resources represented by the resource allocation constrained to a threshold value over a defined period of time. An optimization component is configured to determine an allocation of the set of resources to the plurality of factors having a maximum utility given the constraint, the estimated per unit value, and the estimated covariance matrix.

In accordance with another aspect of the present invention, a method is provided for optimal allocation of a set of resources to a plurality of factors. An estimated per unit value is determined for each of a plurality of factors. An estimated covariance matrix is determined for the plurality of factors. An optimal risk aversion parameter is determined via a second order optimization process according to input from a user. An allocation of the set of resources to the plurality of factors having a maximum utility is determined given the risk aversion parameter, the estimated per unit value, and the estimated covariance matrix via an optimization algorithm.

In accordance with yet another aspect of the present invention, a system is provided for determining an optimal asset allocation for an individual from an initial asset allocation comprising a plurality of accounts. The system includes a processor and a non-transitory computer readable medium operatively connected to the processor and storing machine executable instructions. The machine executable instructions include a parameter estimation component configured to determine an estimated return vector representing a plurality of factors, an estimated covariance matrix for the plurality of factors, and a synthetic time series randomly generated from historical return values selected for each of the plurality of factors. Each of the factors representing investable assets. A user interface is configured to allow a user to indicate a degree of risk tolerance for each of the plurality of accounts. A risk evaluation component is configured to determine, for each of the plurality of accounts, a constraint for the resource allocation from the synthetic time series, such that a conditional value at risk for a set of resources represented by the resource allocation is constrained to a threshold value over a defined period of time. An optimization component is configured to determine the optimal asset allocation to the plurality of factors having a maximum utility given the constraint for each account, the degree of risk tolerance for each account, the estimated return vector, and the estimated covariance matrix.

### BRIEF DESCRIPTION OF THE DRAWINGS

The features, objects, and advantages of the invention will become more apparent from the detailed description set forth below when taken in conjunction with the drawings, wherein:

FIG. 1 illustrates a system for optimal allocation of resources to a plurality of factors in accordance with an aspect of the present invention;

FIG. 2 illustrates a method for optimal allocation of a set of resources to a plurality of factors;

FIG. 3 illustrates an example method for optimized resource allocation in the field of quantitative asset allocation and analysis; and

FIG. 4 is a schematic block diagram illustrating an exemplary system of hardware components capable of implementing examples of the systems and methods disclosed in FIGS. 1-3.

### DETAILED DESCRIPTION OF THE INVENTION

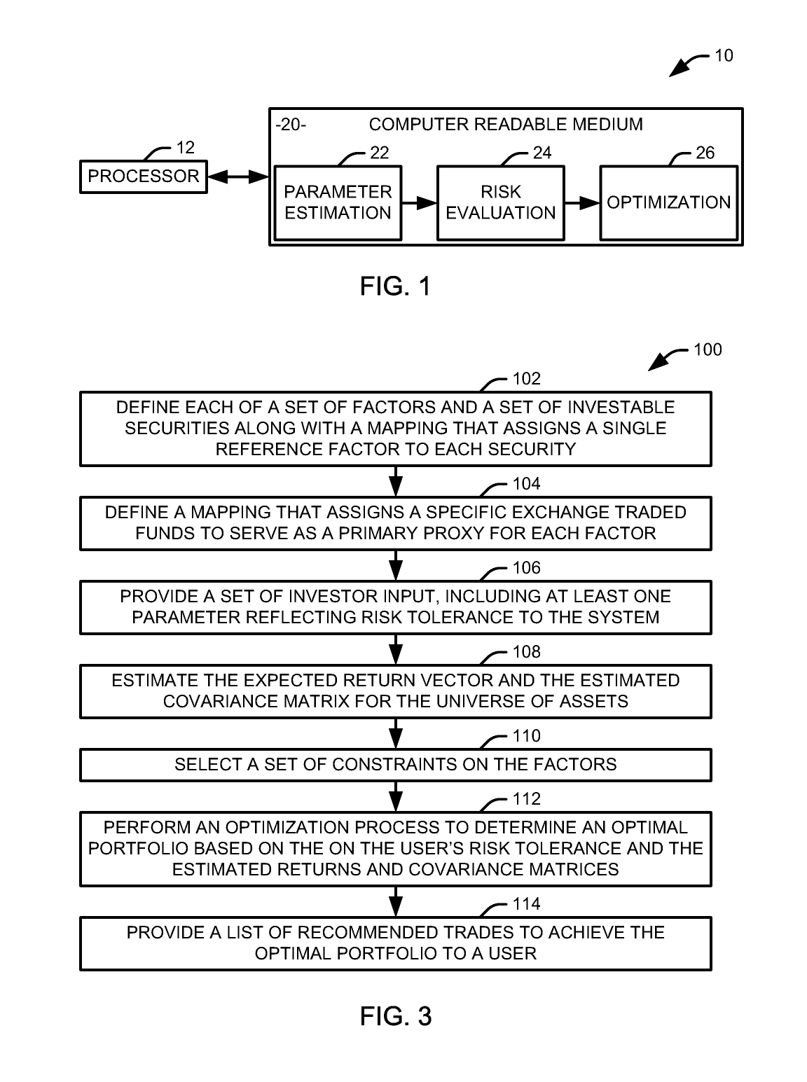

FIG. 1 illustrates a system 10 for optimal allocation of resources to a plurality of factors in accordance with an aspect of the present invention. It will be appreciated that the plurality of factors can be any appropriate options for allocating available resources. Each factor can have an expected per unit value, representing a “return” relevant to an objective function for the optimization expected for each unit of resource applied to the factor. It will be appreciated that the return does not need to be of the same nature as the invested resource. For example, the expected return for an allocation of money or time to a factor such as inoculations could be a reduction in a specific disease incidence at defined time in the future. The allocated resources, return, and factors will vary with the application.

The system 10 includes a processor 12 and a non-transitory computer readable medium 20 operatively connected to the processor and storing machine executable instructions. A parameter estimation component 22 is configured to determine an estimated per unit value for each of a plurality of factors and an estimated covariance matrix for the plurality of factors. It will be appreciated that, when possible, the estimated per unit value for each of the plurality of factors can be determined, at least in part, from historical performance of the factor on similar problems. In one implementation, the historical performance for a specific factor (e.g., a specific antibiotic or a municipal bond) can be combined with historical performance for a category to which the factor belongs (e.g., antibiotics or bonds) to provide an aggregate value, for example, as a weighted average. In another implementation, the estimated per unit value for each the plurality of factors as a weighted average of an informed prior and an estimated set of values calculated using a Black-Litterman model.

Similarly, the parameter estimation component 22 can determine the estimated covariance matrix for the plurality of factors by determining a sample covariance matrix from historical per unit values for the plurality of factors and applying a Bayesian shrinkage model to shrink the sample covariance model towards an informed prior. It will be appreciated that the other means can be utilized for determining the per unit returns and the covariance matrix in accordance with the present invention. In accordance with an aspect of the present invention, the parameter estimation component 22 can be configured to generate a set of synthetic returns for each factor in addition to the expected values. The synthetic returns are time series of simulated returns for each factor over a specified period. In one implementation, they are selected via a process of randomly sampling historical returns.

A risk evaluation component 24 is configured to determine a constraint for the resource allocation from the synthetic time series, such that a conditional value at risk for a set of resources represented by the resource allocation constrained to a threshold value over a defined period of time. In one implementation, the set of resources comprises a plurality of discrete subsets of resources. One example of this could involve segregation of volunteer or employee time for a project via geographic location, with each general location representing a discrete resource subset. Since poor returns from investments of resources from different subsets can have different results, the risk evaluation component can determine a bound on the conditional value at risk for each discrete subset of resources from the synthetic time series. Additional constraints can also be determined for the various discrete subsets of resources. In one example, resources from a given subset can be limited, such that resources from the subset cannot be invested in one or more of the plurality of factors. The constraints on these subsets could reflect an additional optimization cost to assigning the resources, such as the expense of transporting employees to a remote location. In another implementation, the discrete subsets of resources could be individual financial accounts, with the restraints regarding legal or user-selected constraints on the individual factors to which money from the accounts can be assigned.

In one implementation, the risk evaluation component 24 assigns a largest permissible loss over a specified horizon for each of the discrete subsets of resources according to input from the user. These value can be used in the calculation of the conditional value at risk or in determining an overall acceptable risk for the user. In general, the user would assign a maximum permissible loss for each account. Where the user has not done so, the risk evaluation component determines a largest permissible loss for any account for which the largest permissible loss is not defined by the user as

$${D}_{a} = {D}_{p} \frac{{x}_{a} log ( {h}_{a} )}{XC log ( {h}_{p} )} ,$$

where Dₚ is the largest tolerable loss across all subsets, Dₐ is the largest tolerable loss in subset a, A is the number of subsets, X is the total amount of resources in the portfolio, xₐ is the the amount of resources in subset a, hₐ is a horizon of account a, hₚ is the horizon of the aggregate set of resources, and

$$C = {\sum }_{a ∈ A} \frac{log ( {h}_{a} )}{log ( {h}_{p} )} .$$

An optimization component 26 is configured to determine an allocation of a set of resources to the plurality of factors having a maximum utility given the set of constraints, the estimated per unit value, and the estimated covariance matrix. Specifically, the optimization component attempts to determine

$${max}_{x} E ( U ) = \hat{μ} x - κ {x}^{T} \hat{Σ} x ,$$

subject to x≧0 and x^{T}·1=X, where \hat{μ} is a vector of estimated returns for the plurality of factors, \hat{Σ} is the estimated covariance matrix for the plurality of factors, κ is a risk aversion parameter specific to a given user, x is a vector of allocated resources, and X is the total amount of resources to be allocated. The risk aversion parameter can be determined, for example, from the maximum permissible loss values provided by the user. In one implementation, the risk evaluation component determines an optimal risk aversion parameter via a second order optimization process according to the values provided by the user, and the optimization component determines allocation of the set of resources to the plurality of factors according to the constraint, the risk aversion parameter, the estimated per unit value, and the estimated covariance matrix. The resulting optimized resource allocation can then be provided to the user via an appropriate output device.

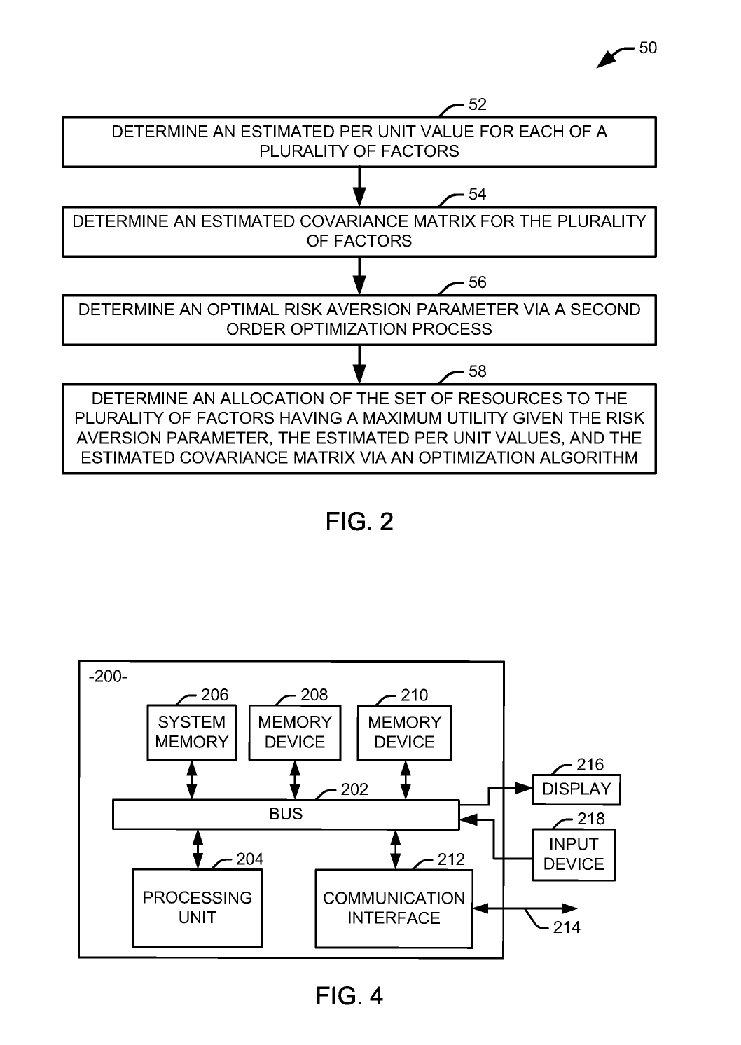

FIG. 2 illustrates a method 50 for optimal allocation of a set of resources to a plurality of factors. At 52, an estimated per unit value is determined for each of a plurality of factors. In addition to the estimated per unit values, a synthetic time series randomly generated from historical values selected for each of the plurality of factors, to simulate future per unit values for the factor. At 54, an estimated covariance matrix is determined for the plurality of factors.

At 56, an optimal risk aversion parameter is determined via a second order optimization process according to input from a user. In one implementation, the second order optimization process finds

$${min}_{K} CVAR ( x ) ,$$

subject to CVAR(X)≧cvar_{g} and

$$E ( U ( x ) ) = {max}_{x} E ( U ( x ) ) ,$$

where CVAR(x) is a conditional value at risk given a portfolio, x, cvar_{g} is a user defined bound on the conditional value at risk, and U(x) is a utility function given the portfolio, x. At 58, an allocation of the set of resources to the plurality of factors having a maximum utility is determined given the risk aversion parameter, the estimated per unit value, and the estimated covariance matrix via an optimization algorithm. In one implementation, the optimization algorithm can be subject to a constraint, determined such that a conditional value at risk for the set of resources is constrained below a threshold value over a defined period of time.

FIG. 3 illustrates an example method 100 for optimized resource allocation in the field of quantitative asset allocation and analysis. Specifically, the method 100 provides an optimal asset allocation in the presence of real world constraints such as existing fixed investments, multiple investment horizons, limited asset availability and differing tax treatment among accounts. In general, an individual invests in a particular asset in the hope that the asset will appreciate in value over some time horizon, providing the investor with income in the future. Individual investments are often analyzed according to their expected risk and expected return. Over a particular time interval, the asset's value, that is, the dollar amount which it can be sold in the market, will likely change.

To establish the terminology for the description of FIG. 3, a period over which the asset is held can be divided this period into N time periods, with the beginning of each period denoted as tₙ, where n goes from 0 to N in steps of one. The value of the asset at each period tₙ can be denoted pₙ. The amount of the change in percentage terms over a time period, n, is called the return, Riₙ, and can be either positive (profit) or negative (loss), such that:

$${R}_{n} = \frac{{p}_{n} - {p}_{n - 1}}{{p}_{n - 1}} \qquad Eq . 1$$

At the end of the time horizon, t_{N}, the total return, TR, for the time horizon is given by:

$$TR = \sqrt[N]{{\prod }_{i = 1}^{N} ( 1 + {R}_{i} )} \qquad Eq . 2$$

The risk of a particular asset can be quantified in a slightly less intuitive way as the variance or deviation of the return time series, {Rₙ}. The mean, μ, and deviation, σ, can be defined as follows:

$$\begin{matrix}μ = \frac{1}{N} {\sum }_{i = 1}^{N} {R}_{i} & Eq . 3 \\ {σ}^{2} = \frac{1}{N} {\sum }_{i = 1}^{N} {( μ - {R}_{i} )}^{2} & Eq . 4\end{matrix}$$

The deviation of the time series quantifies the dispersion of returns around the average return of the asset and thus measures the “risk” of the asset in the sense of how far each return is, generally, from the mean. For a portfolio of K assets:

$${R}_{p} = {\sum }_{k = 1}^{K} {w}_{k} {R}_{k} \qquad Eq . 5$$

where R ₚ is the portfolio return and wₖ is the weight of the k^{th} asset. And the portfolio volatility of the K assets is defined as:

$${σ}_{p}^{2} = {\sum }_{j = 1}^{K} {\sum }_{k = 1}^{K} {w}_{j} {w}_{k} {σ}_{jk}^{2} \qquad Eq . 6$$

where σⱼₖ² is the covariance of the j^{th} and k^{th} assets when j≠k and the variance of the k^{th} asset when j=k .

A rational investor prefers a higher return, Rₚ, and a lower risk, σₚ², with all else being equal. This concept can be ted as a utility function which is an increasing function of return and a decreasing function of risk. For the purposes of the illustrated method 100, one example of a suitable utility function is:

U=Rₚ−κσₚ² Eq. 7

where κ>0 is a measure of risk aversion, which is specific to the individual investor and measures the amount of risk the investor is willing to bear for an additional unit of return.

Investors are assumed to prefer the highest attainable utility. Assume that the investor has X dollars to invest in a portfolio of K assets and that xₖ is the dollar amount invested in a k^{th} asset. We will limit this analysis to the case where xₖ≧0 for 0<k≦K since this is a realistic constraint faced by the majority of retail investors (notably in 401(k) accounts and HSAs) and it simplifies the analysis. It will be appreciated, however, that it would be straightforward to extend this algorithm to operate with short positions as well. If we represent {xₖ} as a K×1 vector x, then

U=R^{T}·x−κx^{T}Σx Eq. 8

where R is a K×1 vector of asset returns and Σ is the K×K covariance matrix of the asset returns.

At the time of investment, t₀, the time series {Pₙ} is, in general, an unknown random variable. According, an estimate of future values is limited to information available at the time of the investment. The expected utility, E(U), is a function of the best estimate of the return and risk according to some prior distribution, E(R) and E(Σ), requiring estimates for E(R) and E (Σ), denoted as \hat{μ} and \hat{Σ}, respectively. The investor can only utilize historical data to compute these estimates, which are not even necessarily stable over time. Further, the investor must also choose a value of κ that accurately reflects his or her future risk tolerance. The problem can be conceptualized as

$${max}_{x} E ( U ) = \hat{μ} x - κ {x}^{T} \hat{Σ} x ,$$

subject to x≧0 and x^{T}·1=X, where X is the dollar amount to be invested. By framing the problem as a Quadratic Programming problem with linear constraints, the method deals with a convex solution set, allowing for efficient determination of a solution, assuming one exists.

The method provides a practical framework for solving this problem in the presence of typical constraints faced by investors. In-general, low-cost indexing strategies are best suited for the typical investor. When indexing initially became popular, mutual funds provided a vehicle to track a particular index for a relatively low cost without necessitating the investor to directly hold the underlying index constituents. A typical investor would allocate a portfolio across two broad asset categories, stocks, in particular high-capitalization US stocks, and bonds, typically a mix of relatively low credit-risk bonds with a spectrum of maturities. This popular stock/bond mix was particularly advantageous due to the negative or low historical correlation of bonds with stocks. This low correlation allows the investor to realize, through a diversified portfolio, a utility higher than would otherwise be possible from investing solely in either particular asset.

Recent years have seen the growth of Exchange Traded Funds (ETFs). These are assets that track a particular index, but can be easily traded by retail investors on an exchange. Whereas investors formally had access to only a small number of index-tracking investments, today an investor can invest in ETFs that track indices as diverse as emerging market growth equities, Treasury Inflation-Protected Securities (TIPS), or even commodities. Given the covariance among these different indices, today's investor has the opportunity to cheaply and easily diversify a portfolio, realizing a risk/return profile more attractive than one available through the two-asset allocation strategy.

The asset allocation system utilized in the method selects a mixture of theoretical asset exposures, corresponding to the factors of FIGS. 1 and 2, that will maximize the investor's expected utility, that is to say it will determine the allocation mix that will provide the highest expected return for an investor for given risk tolerance. In practice, an allocation to a given factor will be realized through a specific trade-able asset, generally an ETF, that tracks an index corresponding to that factor. For example, given a factor universe consisting solely of stocks and bonds, the invention would determine the dollars to allocate to an ETF tracking stocks, say the ETF SPY which tracks the S&P 500 index, a broad and popular measure of stock performance, and the ETF AGG, which tracks a broad range of bond investments.

Accordingly, at 102, each of a set of factors, Θ, and a set of investable securities, S, are defined along with a mapping, fᵣ:S→Θ, that assigns a single reference factor to each security. At 104, a mapping, fₚ:Θ→S, is defined that assigns a specific ETF to serve as a primary proxy for each factor θ ∈ Θ, referred to as a set of proxy securities, S_{II}.

At 106, a set of investor input, including at least one parameter reflecting risk tolerance, is provided to the system via a user interface. In one example, an investor can log on to the system and provide it with detailed information concerning the current structure of the investor's portfolios as a set of user accounts, A. This information can be provided either by allowing the invention access to the investor's online accounts via a third-party service such as Yodlee, or by the investor directly inputting the relevant information. This information could include the type of each account as chosen from a fixed list (e.g., brokerage, 401(k), Roth IRA, etc.), the shares of any existing securities held in each account along with any cost-basis information including purchase dates and prices ideally. For each account, the investor can input the investment horizon in years for that particular account. The system will suggest a horizon based on the investor's age and the type of account. For example, if the investor has her child's college savings in a 529 account, then the investor would reasonably want the investment horizon to be no longer than the date at which the child is expected to begin withdrawing funds from the account. For a retirement account such as an IRA, the investment horizon would be a function of how many years are left before the investor plans to retire and begin withdrawing funds. The user can also input an expected marginal income tax rate.

In accordance with an aspect of the present invention, the investor can input the investment universe allowed to each account as a constraint on the optimization process of the illustrated method. An investment universe is the collection of securities which each account is able to trade. Each account's investment universe will consist of the ETFs or mutual funds which proxy the investment factors, any existing positions that are held in each account, and any security that the user may want to serve as an additional factor proxy. These sets of tuples are referred to herein as {(s,a) ∈ S×A}, Iₚ, I_{F}, and I_{E} respectively. For a self-directed brokerage account, this universe may be without many restrictions and would allow the investor to select from all ETF and stocks traded on the major US exchanges. For an employer-provided 401(k), however, the investment universe may be restricted to a limited set of mutual funds offered by that particular 401(k) account provider.

The user can also identify any further constraints to be imposed upon the portfolio. This includes identifying any existing positions which the investor may want or may be constrained to keep. This could be a consequence of a required holding period imposed by an employer or a sentimental attachment to a block of inherited stock. Additionally, the investor may specify a portion of fixed shares of her portfolio to be held in a particular stock perhaps because the investor believes the particular stock or asset to be a particularly good investment. The optimization uses these constraints to find the optimal portfolio that includes these positions. Finally, the user provides the system information on her risk tolerance. In one example, this is quantified by asking the user to specify, in percentage or absolute dollar terms, the largest loss over some specified horizon, such as one month, which can be tolerated in each account as well as in the portfolio as a whole. If the loss is not specified for a particular account, it is calculated as follows:

$${D}_{a} = {D}_{p} \frac{{x}_{a} log ( {h}_{a} )}{XC log ( {h}_{p} )} \qquad Eq . 9$$

where Dₚ is the largest tolerable dollar loss for the whole portfolio, Dₐ is the largest tolerable loss in account a, A is the number of accounts, X is the total dollar amount of the portfolio, xₐ is the dollar amount in account a, and hₐ is the horizon of account a, hₚ is the horizon of the portfolio as a whole, and

$$C = {\sum }_{a ∈ A} \frac{log ( {h}_{a} )}{log ( {h}_{p} )} .$$

The universe of investible assets is thus fixed as I=Iₚ∪I_{E}∪I_{F} and the method finds X ∈ X={s×a: s ∈ p₁(I),a ∈ A} that maximizes the utility.

At 108, the expected return vector \hat{μ} and the estimated covariance matrix \hat{Σ} are estimated for the universe of assets. In one implementation, the covariance matrix is estimated from a sample covariance matrix from ten years of trailing historical data. To this end, a matrix, R, is constructed where each element, rₖₜ, is the one-period log return of a security, sₖ ∈ S_{II}, at time t. Any columns of the matrix where rⱼₜ is undefined are droped and the sample covariance matrix \hat{Σ}^{(s)} is calculated, equally weighting the columns. Unfortunately, the sample covariance matrix is a poor predictor of the future covariance of security returns. To this end, the implementation can utilize a Bayesian Shrinkage model where the sample covariance is “shrunk” towards an informed prior \hat{Σ}^{(p)} to provide the estimated covaraince matrix. The informed prior can come from any of a number of sources. In one implementation, the method 100 uses published research incorporating longer term historical data and forward looking information representing the market outlook from sjbject matter experts. In the worse case, where no relevant data is unavailable, an uninformed prior can be utilized for the Bayesian Shrinkage model.

In the same or another implementation, the estimate of the expected long-term return of the factors, \hat{μ}, combines the implied returns implied from a Black-Litterman model with an informed prior. The informed prior \hat{μ}^{(p)} is taken from public research by those with domain-specific knowledge of each asset class utilizing forward-looking information. To compute the Black-Litterman implied long term return \hat{μ}^{(b)}, the estimated covariance matrix, \hat{Σ}, along with a vector, ŵ, of estimated market capitalizations of each of the investable factors. Estimating w is not trivial. While the capitalization of some factors like large cap US stocks may be easy to calculate simply by using publicly available information, calculating the total outstanding market capitalization of all emerging market sovereign bonds is not so straightforward and requires domain specific knowledge. The method 100 therefore utilizes published estimates of w whenever possible. The model is then calibrated by choosing a global risk aversion parameter that implies a long-term return for a well-studied factor that matches our informed prior estimate. The final estimate of \hat{μ} is a weighted average of \hat{μ}^{(b)} and \hat{μ}^{(p)}.

It will be apprecitated that the factors are artificial constructions and that it is cannot invest directly in any of these factors and must approximate the factor investment by purchasing a physical security that serves as a proxy for each factor that can be held in that particular account. The proxy is selected to serve as a representatives for their respective factors, and it is assumed that they have the same underlying covariance structure. For any non-proxy securities in the portfolio, the invention calculates a reasonable covariance structure by invoking a single-factor return model using empirical betas to their reference factors. The sample covariance matrix, \hat{Σ}^{(s)}, is calculated over the securities in a set Sₐ={s ∈ P₁(I)}, in the same fashion as the factor covariance matrix. Given that each security in S_{E} is associated with a reference factor in Θ, a calculate a vector, \hat{β}, of beta estimates with respect to each securities reference factor. Where possible, beta values computed by a vendor that has deep domain knowledge and can incorporate a forward looking component, such as BARRA, can be utilized.

Where such values aren't available, a vector of estimates, \hat{β}ₖ, can be determined as the estimated coefficient from a linear regression of {(rᵢ^{(k)}} against {rᵢ^{(j)}} where sⱼ, sₖ ∈ Sₐ and sⱼ is the the proxy security of security sₖ's reference factor. If the reference factor of security sₖ is not provided by the user or known to the system already, then the factor is chosen from Θ by running linear regressions against all s ∈ Sₚ and choosing the factor that produces the highest R². If there are K securities in S₁, then the full covariance matrix, \hat{Σ}^{(p)}, is constructed by decomposing the prior on the factor covariance matrix \hat{Σ}^{(F)} into a correlation matrix C^{(F)} and a vector σ^{(F)} of factor deviations. Next, a Capital Asset Pricing Model (CAPM) is used to construct the a K×1 vector a of deviations where:

$${σ}_{k} = \{ \begin{matrix}{σ}_{k}^{( F )} & {s}_{k} ∈ {p}_{1} ( {I}_{P} ) \\ {{σ}_{k}^{( F )} ( {\hat{β}}_{k} )}^{2} & {s}_{k} ∉ {p}_{1} ( {I}_{P} )\end{matrix} \qquad Eq . 10$$

The K×K matrix, C , is constructed where each element cᵢⱼ=c_{ab}^{(F)}, a=fᵣ(sᵢ) is the reference factor of sᵢ, and b=fᵣ(s ⱼ). Finally, the prior covariance matrix \hat{Σ}^{(p)}=(I_{K}σ)C(I_{K}σ) is recomposed. The full estimated covariance matrix \hat{Σ} is then computed as the sample matrix \hat{Σ}^{(s)} “shrunk” towards the prior, \hat{Σ}^{(p)}.

The security return vector, \hat{μ}, is computed as the weighted average between the estimated return vector, \hat{μ}^{(s)}, and the prior return vector, \hat{μ}^{(p)}. Again, the CAPM model can be used to compute each element of \hat{μ}^{(s)} as:

$${\hat{μ}}_{j}^{( s )} = \{ \begin{matrix}{\hat{μ}}_{j}^{( b )} & j ∈ {S}_{p} \\ {\hat{μ}}_{j}^{( b )} {\hat{β}}_{j} & j ∉ {S}_{p}\end{matrix} \qquad Eq . 11$$

Similarly,

$${\hat{μ}}_{j}^{( p )} = \{ \begin{matrix}{\hat{μ}}_{j}^{( p )} & j ∈ {S}_{p} \\ {\hat{μ}}_{j}^{( p )} {\hat{β}}_{j} & j ∉ {S}_{p}\end{matrix} \qquad Eq . 12$$

At 110, a set of constraints on the factors is selected. Many investors do not simply hold all their securities in a single investment account, and instead hold their investments across a diverse range of investment vehicles over which they have varying degrees of freedom. A typical investor may have a savings account, a 401(k), a Roth IRA, a 529 College account, a spouse's brokerage account, and a spouse's Traditional IRA. The method 100 finds the optimal allocation across all these accounts, and even accounts for the risk and return generated from accounts over which the investor has no control. For a set of investor accounts, A, having n elements each account, a ∈ A, an expected return, \hat{μ}ₐ can be defined as:

$${\hat{μ}}_{a} = \{ \begin{matrix}( 1 - ρ ) e \hat{μ} - \hat{ι} 1 & a ∈ {A}_{U} \\ ( 1 - ρ ) e ( ( 1 - {t}_{u} ) \hat{μ} ey + ( 1 - {t}_{g} ) \hat{μ } e ( 1 - y ) ) - \hat{ι} 1 & a ∈ {A}_{T}\end{matrix} \qquad Eq . 13$$

where ρ is a vector where each element, ρⱼ, is the expense ratio of security j, y is the portion of the security's return in the form of taxable income, \hat{l} is the estimated long-term rate of inflation, tᵤ is the marginal tax rate rate of the particular user and t_{g} is the tax rate on long term capital gains and qualified dividends, A_{U} is the set of tax advantaged accounts and A_{T} is the set of taxable accounts, and e denotes element-wise multiplication.

A vector, \hat{μ}^{(A)}, representing an aggregrate return for the portfolio, can be constructed by stacking all the vectors for accounts comprising the portfolio:

$${\hat{μ}}^{( A )} = [ \begin{matrix}{\hat{μ}}^{( {a}_{1} )} \\ {\hat{μ}}^{( {a}_{2} )} \\ ⋮ \\ {\hat{μ}}^{( {a}_{n} )}\end{matrix} ] \qquad Eq . 14$$

Likewise, an n×n block matrix \hat{Σ}^{(A)} can be constructed where each block is the matrix \hat{Σ} for a given account.

While deviation of returns can be utilized as a measure of risk, it is by no means the only or necessarily the best way to quantify risk. It can be criticized both for its assumption of normally distributed returns as well as its symmetrical penalization of both positive and negative returns. Another risk metric is known as Value at Risk (VaR). The p % VaR is the dollar loss such that there is a p % chance of the portfolio experiencing a loss of this magnitude or greater. This metric makes no assumptions on the structure of the underlying distribution, and it focuses on downside risk. Unfortunately, VaR has limitations, as it ignores any information contained in the tail of the distribution to the left of the threshold and does not exhibit the property of sub-additivity.

The method 100 utilizes a metric called Conditional Value at Risk, or CVaR, to set the constraints, which is defined as the expected loss on given default that your loss already meets or exceeds the p % VaR. Not only does CVaR incorporate the tail distribution in a non-parametric fashion, but it also exhibits subadditivity. Subadditivity is a property of a function in which the value of the function for the sum of two elements of the domain is always less than or equal to the sum of the value of the function at the first element and the value of the function at the second element. By using a subadditive function, the method can control risk within the individual accounts as well as an overall risk. Given the reality that one can never fully eliminate risk and that the only bound on a stock's loss is at zero, CVaR, provides a reasonable approximation of what a “really bad day” looks like to that particular investor. Additionally, it measures this idea in actual dollars losses, a concept much more intuitive to an investor than measuring risk in terms of unit-less deviations.

When the system asks the user to estimate their tolerable loss is for a particular account, the invention can impose some reasonable bounds on the expectation of such a loss occurring. For instance, an investor with a 529 account valued at $60,000 and a child who will begin withdrawing funds for college in one year, it may reasonable say that if the account were to fall below $50,000 in value that funds for tuition would have to come from another source, and thus a $10,000 loss may be considered the maximum dollar loss that this investor would tolerate. In another sense, one can think of a CVaR bound as the loss beyond which the investor capitulates in a down-market thereby locking in the already considerable loss. Formally, CVaR(x,β)=E(R(x)|R(x)≦α(x,β)), where α(x,β) is the β % XaR.

The invention uses a methodology in which the portfolio is still optimized in the mean-variance sense, but with constraints placed on the CVaR of the individual accounts to control tail risk at a level where there is generally some defined investment horizon, not only over a realized history of returns, but over a set of simulated returns. This achieves a more robust and forward-looking risk mitigation capable of protecting a portfolio from a wide range of market shocks. To simulate market returns, one approach has been to model returns in a parametric fashion. This approach suffers from model bias where the optimized solution is sensitive to the model specification. For example, modeling returns as independent Gaussian random walks underestimates tail risk and any higher moment features, the very features which we are attempting to mitigate.

Accordingly, the method uses an empirical approach based on a bootstrap methodology. To this end, a set of C simulated D-day returns are constructed. Let rₜ be a vector of returns at a time, t, where the elements of r are defined as:

$${r}_{it} = \{ \begin{matrix}{r}_{it} , & {r}_{it} ∈ \\ {r}_{jt} {\hat{β}}_{i} , & {r}_{it} ∉\end{matrix} \qquad Eq . 15$$

where the index, i, indicates a factor or security, j is a reference security of security or factor i, and [symbol] is the set of real numbers.

Let {rₜ} be the time series of nxl vectors of daily historical realized returns indexed at time t, where t ranges from t=0 on a date ten years prior to the date of the optimization to the present, time T. A synthetic time series of length N is then generated randomly from two discrete distributions, s˜U(0,T−1) and l˜U(1,L) where 1<L<D, and U(a,b) is the discrete uniform distribution between a and b. N is chosen to be a multiple of T and is constrained by the computing resources available to our optimization by repeatedly concatenating the subseries {rₜ|s≦t≦t+l} to form {rₜ′}. Finally, a series of monthly (e.g., twenty-one business day) cross sectional returns is constructed, {rₘ′}, with geometric averaging of length N′.

At 112, an optimization process is performed to maximize utility based on the on the user's risk tolerance and the estimated returns and covariances. To this end, the system sets up the objective function for the optimization as described previously, but replacing the expected returns and the expected covariances of the factors with the aggregrate versions of these values across the plurality of accounts, \hat{μ}^{(A)} and \hat{Σ}^{(A)} to provide:

$${max}_{x} E ( U ) = {\hat{μ}}^{( A )} x - κ {x}^{T} {\hat{\sum }}^{( A )} x \qquad Eq . 16$$

The optimization is subject to a number of constraints, so the final solution for x will be the solution that maximizes the utility in Eq. 16 subject to:

1. x≧0;

2. 1^{T}x=d;

3. 1^{T}x^{(a)}=dₐ, ∀a ∈ A, where dₐ is the dollar amount of all securities and cash in account a;

4 (π^{(a)})^{T}x^{(a)}=0, ∀a ∈ A where πₐⱼ=1 if security sⱼ ∉Sₐ and 0 otherwise;

5. Fx=f where each entry Fᵢⱼ=1if sⱼ ∈ S_{F} and i=j and f is the vector of fixed positions;

6. Gx≦h where Gᵢⱼ=1 if f(sⱼ)=θᵢ for i=1,2, . . . , n and hᵢ=B_{U}(θᵢ) where there are n factors and B_{U}(θ) is the upper dollar bound on factor θ;

7. Gx≦h where G_{i,j}=−1 if f(sⱼ)=θᵢ for i=1,2, . . . , n and hᵢ =−B_{L}(θᵢ) where there are n factors and B_{L}(θ) is the lower dollar bound on factor θ;

8. Gx≦h where G_{i,j}=1 if i=j and hᵢ=B_{U}(sⱼ,a_{┌jm┐}) where B_{U} (s,a) is the upper dollar bound on security s in account a and there are m accounts;

9. Gx≦h where G_{i,j}=−1 if i=j and hᵢ=−B_{L}(sⱼ,a_{┌jm┐}) where B_{L}(s,a) is the lower dollar bound on security s in account a and there are m accounts

10. y^{(a)}≧0, a ∈ A

11.

$${v}^{( a )} - \frac{{1}^{T} {y}^{( a )}}{ητ} \geq {δ}^{( a )} ,$$

a ∈ A, where v^{(a)} is a free variable in the optimization; and

12. yₜ^{(a)}≧v^{(a)}−rₘ^{T}x^{(a)}, a ∈ A, m=1, . . . N^{t}, where rₘ is the vector of cross-sectional returns for the portfolio at time t.

The factor bounds defined by B_{U}(θ) and B_{L}(θ) are defined ex-ante and can be overridden by the user. The lower bounds set on each security, B_{L}(s,a), ensure that only long-term or underwater holdings will be sold, avoiding unfavorable tax consequences. The upper bounds are set on each security such that the maximum dollar amount B _{L}(s,a)=max(d_{a,s}, τdₐ), where d_{a,s} is the dollar amount of the security in the particular account prior to optimization, dₐ is the dollar amount in account a, and τ ∈ [0,1] is a global maximum concentration parameter. Constraints 10-12 constrain solutions to bound the τ % CVaR per account to be less than a parameter, δ^{(a)}. The parameter, δ^{(a)}, can be either directly user defined or calculated from user input.

Due to the external constraints on the portfolios, this problem is not guaranteed to be feasible. For example, where there exists some maximum bound on a particular factor, the user's existing positions may already violate this condition and simultaneously have their share amounts fixed. In this case the user will be informed of the infeasibility and be asked to rerun the optimization with relaxed constraints.

As part of the optimization process, the method ascertains the risk aversion of the particular investor as a precise value for κ. The method approximates κ via a second-order optimization wherein κ is chosen so that the portfolio CVaR is as close as possible to cvar_{g}, a global CVaR bound entered by the user. The risk aversion parameter optimization process can be expressed as

$${min}_{K} CVAR ( x )$$

subject to CVAR(x) cvar_{g} and

$$E ( U ( x ) ) = {max}_{x} E ( U ( x ) ) .$$

The solution κ* is then used as the risk aversion parameter in the optimization problem to determine the optimal portfolio, x^{*}.

Once the method has determined the optimal portfolio, a set of recommended trades are then determined and provided to the user at 114. Specifically, the method recommends to the user a set of trades T that, once executed on the existing portfolio x^{(e)} will result in a close approximation of the optimal portfolio, x^{*}, with minimal tax consequences. Trades under a certain absolute dollar threshold, in one example about $500, are ignored. Since the optimization is constrained to avoid short term capital gains, the selected trades are tax optimized. Any liquidating trade is reported along with the accounting-specific basis on which to calculated the realized gain or loss. For example, if the user has selected “specified lot” accounting, then each sell will report a list of specific lots (which may be partial lots) that minimize the realized gain (or maximize the loss) at the time of the liquidating trade.

FIG. 4 is a schematic block diagram illustrating an exemplary system 200 of hardware components capable of implementing examples of the systems and methods disclosed in FIGS. 1-3. The system 200 can include various systems and subsystems. The system 200 can be a personal computer, a laptop computer, a workstation, a computer system, an appliance, an application-specific integrated circuit (ASIC), a server, a server blade center, a server farm, etc.

The system 200 can includes a system bus 202, a processing unit 204, a system memory 206, memory devices 208 and 210, a communication interface 212 (e.g., a network interface), a communication link 214, a display 216 (e.g., a video screen), and an input device 218 (e.g., a keyboard and/or a mouse). The system bus 202 can be in communication with the processing unit 204 and the system memory 206. The additional memory devices 208 and 210, such as a hard disk drive, server, stand-alone database, or other non-volatile memory, can also be in communication with the system bus 202. The system bus 202 interconnects the processing unit 204, the memory devices 206-210, the communication interface 212, the display 216, and the input device 218. In some examples, the system bus 202 also interconnects an additional port (not shown), such as a universal serial bus (USB) port.

The processing unit 204 can be a computing device and can include an application-specific integrated circuit (ASIC). The processing unit 204 executes a set of instructions to implement the operations of examples disclosed herein. The processing unit can include a processing core.

The additional memory devices 206, 208 and 210 can store data, programs, instructions, database queries in text or compiled form, and any other information that can be needed to operate a computer. The memories 206, 208 and 210 can be implemented as computer-readable media (integrated or removable) such as a memory card, disk drive, compact disk (CD), or server accessible over a network. In certain examples, the memories 206, 208 and 210 can comprise text, images, video, and/or audio, portions of which can be available in formats comprehensible to human beings.

Additionally or alternatively, the system 200 can access an external data source or query source through the communication interface 212, which can communicate with the system bus 202 and the communication link 214.

In operation, the system 200 can be used to implement one or more parts of a predictive modeling system in accordance with the present invention. Computer executable logic for implementing the composite applications testing system resides on one or more of the system memory 206, and the memory devices 208, 210 in accordance with certain examples. The processing unit 204 executes one or more computer executable instructions originating from the system memory 206 and the memory devices 208 and 210. The term “computer readable medium” as used herein refers to a medium that participates in providing instructions to the processing unit 204 for execution.

The invention has been disclosed illustratively. Accordingly, the terminology employed throughout the disclosure should be read in an exemplary rather than a limiting manner. Although minor modifications of the invention will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

Having described the invention, we claim:

1. A system for optimal resource allocation to a plurality of factors comprising:
a processor; and
a non-transitory computer readable medium operatively connected to the processor and storing machine executable instructions, the machine executable instructions comprising:
a parameter estimation component configured to determine an estimated per unit value for each of a plurality of factors, an estimated covariance matrix for the plurality of factors, and a synthetic time series randomly generated from historical values selected for each of the plurality of factors;
a risk evaluation component configured to determine a constraint for the resource allocation from the synthetic time series, such that a conditional value at risk for a set of resources represented by the resource allocation constrained to a threshold value over a defined period of time; and
an optimization component configured to determine an allocation of the set of resources to the plurality of factors having a maximum utility given the constraint, the estimated per unit value, and the estimated covariance matrix.

2. The system of claim 1, wherein the parameter estimation component is configured to determine the estimated covariance matrix for the plurality of factors by determining a sample covariance matrix from historical per unit values for the plurality of factors and applying a Bayesian shrinkage model to shrink the sample covariance model towards an informed prior.

3. The system of claim 1, wherein the set of resources comprises a plurality of discrete subsets of resources, and the risk evaluation component is configured to determine a constraint for each of the plurality of discrete subsets of resources from the synthetic time series.

4. The system of claim 3, wherein the risk evaluation component defines, for each of the discrete subsets of resources, a subset of the plurality of factors to which resources from the discrete subset of resources associated with the constraint can be allocated.

5. The system of claim 3, wherein the risk evaluation component assigns a largest permissible loss over a specified horizon for each of the discrete subsets of resources according to input from the user.

6. The system of claim 5, wherein the risk evaluation component determines a largest permissible loss for any account for which the largest permissible loss is not defined by the user as:
$${D}_{a} = {D}_{p} \frac{{x}_{a} log ( {h}_{a} )}{XC log ( {h}_{p} )}$$
where D ₚ is the largest tolerable loss across all subsets, Dₐ is the largest tolerable loss in subset a, A is the number of subsets, X is the total amount of resources in the portfolio, xₐ is the the amount of resources in subset a, hₐ is a horizon of account a, hₚ is the horizon of the aggregate set of resources, and
$$C = {\sum }_{a ∈ A} \frac{log ( {h}_{a} )}{log ( {h}_{p} )} .$$

7. The system of claim 1, wherein the parameter estimation component is configured to determine the estimated per unit value for each the plurality of factors as a weighted average of an informed prior and an estimated set of values calculated using a Black-Litterman model.

8. The system of claim 1, wherein the set of resources represents money in at least one investment fund and each of the plurality of factors represent an individual investment or category of investments.

9. The system of claim 1, wherein the optimization component determines an optimal risk aversion parameter via a second order optimization process according to input from the user, the optimization component being configured to determine the allocation of the set of resources to the plurality of factors having a maximum utility given the constraint, the risk aversion parameter, the estimated per unit value, and the estimated covariance matrix.

10. A method, implemented as machine executable instructions executed by an associated processor, for optimal allocation of a set of resources to a plurality of factors comprising:
determining an estimated per unit value for each of a plurality of factors;
determining an estimated covariance matrix for the plurality of factors;
determining an optimal risk aversion parameter via a second order optimization process according to input from a user; and
determining an allocation of the set of resources to the plurality of factors having a maximum utility given the risk aversion parameter, the estimated per unit value, and the estimated covariance matrix via an optimization algorithm.

11. The method of claim 10, wherein as the second order optimization process finds
$${min}_{K} CVAR ( x ) ,$$
subject to CVAR (x)≧cvar_{g} and
$$E ( U ( x ) ) = {max}_{x} E ( U ( x ) ) ,$$
where CVAR(x) is a conditional value at risk given a portfolio, x, cvar_{g} is a user defined bound on the conditional value at risk, and U(x) is a utility function given the portfolio, x.

12. The method of claim 10, further comprising determining a constraint for the optimization algorithm, such that a conditional value at risk for the set of resources is constrained below a threshold value over a defined period of time.

13. The method of claim 12, wherein the constraint is determined from a synthetic time series randomly generated from historical values selected for each of the plurality of factors.

14. The method of claim 10, wherein the set of resources represents money in at least one investment fund and each of the plurality of factors represent an individual investment or category of investments.

15. A system for determining an optimal asset allocation for an individual from an initial asset allocation comprising a plurality of accounts, the system comprising:
a processor; and
a non-transitory computer readable medium operatively connected to the processor and storing machine executable instructions, the machine executable instructions comprising:
a parameter estimation component configured to determine an estimated return vector representing a plurality of factors, an estimated covariance matrix for the plurality of factors, and a synthetic time series randomly generated from historical return values selected for each of the plurality of factors, each of the factors representing investable assets;
a user interface configured to allow a user to indicate a degree of risk tolerance for each of the plurality of accounts;
a risk evaluation component configured to determine, for each of the plurality of accounts, a constraint for the resource allocation from the synthetic time series, such that a conditional value at risk for a set of resources represented by the resource allocation is constrained to a threshold value over a defined period of time; and
an optimization component configured to determine the optimal asset allocation to the plurality of factors having a maximum utility given the constraint for each account, the degree of risk tolerance for each account, the estimated return vector, and the estimated covariance matrix.

16. The system of claim 15, wherein the user interface allows the user to define a subset of the plurality of factors to which assets from the associated discrete account can be allocated, the optimization component being constrained by the defined subset for each account.

17. The system of claim 16, wherein the a parameter estimation component determines an estimated account return vector for each account, according to its existing assets and the subset of the plurality of factors to which assets from the associated discrete account can be allocated and forms the estimated return vector by stacking the estimated account return vectors for the plurality of accounts.

18. The system of claim 16, wherein the a parameter estimation component determines an estimated account covariance matrix for each account, according to its existing assets and the subset of the plurality of factors to which assets from the associated discrete account can be allocated and forms the estimated covariance by constructing a block matrix from the estimated account covariance matrices.

19. The system of claim 15, wherein the user interface allows the user to define an asset in the associated discrete account that is fixed, such that the optimization component will not determine an optimal transition allocation in which the fixed asset is transitioned to another investible asset.

20. The system of claim 14, wherein the optimization component is further configured to determine a set of transactions that, when applied to the initial asset allocation, will approximate the optimal asset allocation.
